(19) United States
(12) Patent Application Publication
(10) Pub. No.: US 2014/0285718 A1
(43) Pub. Date: Sep. 25, 2014

(54) MOVING IMAGE EXTRACTING APPARATUS EXTRACTING MOVING IMAGE OF PREDETERMINED PERIOD FROM MOVING IMAGE

(71) Applicant: CASIO COMPUTER CO., LTD., Tokyo (JP)

(72) Inventors: Tomohiko MURAKAMI, Tokyo (JP); Kouichi NAKAGOME, Saitama (JP); Yoshihiro KAWAMURA, Tokyo (JP)

(73) Assignee: CASIO COMPUTER CO., LTD., Tokyo (JP)

(21) Appl. No.: 14/220,065

(22) Filed: Mar. 19, 2014

(30) Foreign Application Priority Data
Mar. 22, 2013 (JP) 2013-061073

(51) Int. Cl. H04N 5/91

(52) U.S. Cl. CPC H04N 5/91
USPC 348/571

(57) ABSTRACT

There is provided an image extracting apparatus including: a CPU 11 that acquires a first moving image; an impact detection processing unit 54 that identifies a predetermined time point in the acquired moving image; an extraction time point identifying unit 55 that calculates reliability of a period of the first moving image; and a moving image storage control unit 56 that extracts a second moving image of a predetermined period according to the predetermined time point and the reliability from the first moving image.

This application is based upon and claims the benefit of priority from the prior Japanese Patent Application No. 2013-061073, filed Mar. 22, 2013, and the entire contents of which are incorporated herein by reference.

### BACKGROUND OF THE INVENTION

1. Field of the Invention

The present invention relates to a moving image extracting apparatus, a moving image extracting method, and a recording medium for extracting a moving image of a predetermined period from the moving image.

2. Related Art

As a conventional technology, in Japanese Patent No. 4,730,402, a technology for recording a moving image only for a predetermined period is disclosed. More specifically, a technology is described which is for recording a moving image of a predetermined period before and after the moment in which a predetermined condition is satisfied by the subject while the moving image is stored in a ring buffer in an endless buffer.

### SUMMARY OF THE INVENTION

An aspect of a moving image extracting apparatus according to the present invention is a moving image extracting apparatus, including:

an acquisition unit that acquires a first moving image;

an identification unit that identifies a predetermined time point in the first moving image acquired by the acquisition unit;

a calculation unit that calculates reliability of a period in the first moving image; and

an extraction unit that extracts a second moving image of a predetermined period according to the predetermined time point and the reliability from the first moving image.

Furthermore, an aspect of a method of extracting a moving image according to the present invention is a method of extracting a moving image using a moving image extracting apparatus, the method comprising:

acquiring a first moving image;

identifying a predetermined time point in the first moving image acquired in the acquisition of the first moving image;

calculating the reliability of a period in the first moving image; and

extracting a second moving image of a predetermined period according to the predetermined time point and the reliability from the first moving image.

Moreover, an aspect of a non-transitory storage medium according to the present invention is a non-transitory storage medium on which a computer-readable program is recorded, the computer-readable program causing a computer to perform functions as:

an acquisition unit that acquires a first moving image;

an identification unit that identifies a predetermined time point in the first moving image acquired by the acquisition unit;

a calculation unit that calculates the reliability of a period in the first moving image; and

an extraction unit that extracts a second moving image of a predetermined period according to the predetermined time point and the reliability from the first moving image.

### BRIEF DESCRIPTION OF THE DRAWINGS

FIG. 1 is a schematic diagram that illustrates an overview of the generation of a moving image by performing high speed photographing according to an embodiment of the present invention.

FIG. 2 is a block diagram that illustrates the hardware configuration of an image capture apparatus according to an embodiment of the present invention.

FIG. 3 is a functional block diagram that illustrates the functional configuration used for performing a swing moving image photographing process, among the functional configurations of the image capture apparatus illustrated in FIG. 2.

FIG. 4 is a functional block diagram that illustrates the functional configuration used for performing an entry detecting process which is included in the swing moving image photographing process.

FIG. 5A is a schematic diagram that illustrates entry detection, including the setting of an area frame.

FIG. 5B is a schematic diagram that illustrates entry detection, including the setting of an area frame.

FIG. 6 is a functional block diagram that illustrates the functional configuration used for performing a ball position identifying process which is included in the swing moving image photographing process.

FIG. 7A is a schematic diagram that illustrates a result of identifying the ball position.

FIG. 7B is a schematic diagram that illustrates a result of identifying the ball position.

FIG. 8 is a functional block diagram that illustrates the functional configuration used for performing an impact detecting process which is included in the swing moving image photographing process.

FIG. 9 is a graph that illustrates an example of variations in an impact evaluation value around an impact.

FIG. 10 is a graph that illustrates another example of the variations in impact evaluation value around an impact.

FIG. 11 is a functional block diagram that illustrates the functional configuration used for performing an address detecting process which is included in the swing moving image photographing process.

FIG. 12 is a flowchart that illustrates the flow of the swing moving image photographing process which is performed by the image capture apparatus having the functional configuration illustrated in FIG. 3.

FIG. 13 is a flowchart that illustrates the detailed flow of the entry detecting process which is included in the swing moving image photographing process that is performed by the image capture apparatus having the functional configuration illustrated in FIG. 4.

FIG. 14 is a flowchart that illustrates the detailed flow of the ball position identifying process which is included in the swing moving image photographing process that is performed by the image capture apparatus having the functional configuration illustrated in FIG. 6.

FIG. 15 is a flowchart that illustrates the detailed flow of the impact detecting process which is included in the swing moving image photographing process that is performed by the image capture apparatus having the functional configuration illustrated in FIG. 8.

FIG. 16 is a flowchart that illustrates the detailed flow of the address detecting process which is included in the swing moving image photographing process that is performed by the image capture apparatus having the functional configuration illustrated in FIG. 11.

FIG. 17 is a graph that illustrates an example of a transition in the identification score of a frame prior to the frame including the impact.

FIG. 18 is a graph that illustrates an example of a transition in the identification score of a frame after the frame includes the impact.

### DETAILED DESCRIPTION OF THE INVENTION

Hereinafter, embodiments of the present invention will be described with reference to the drawings.

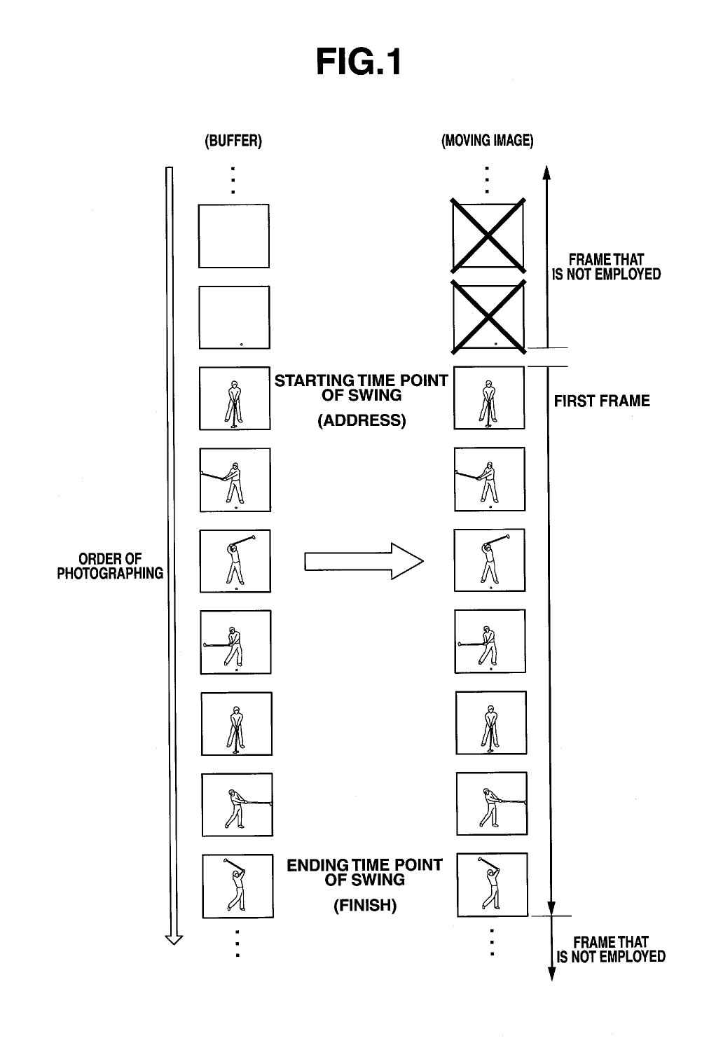

FIG. 1 is a schematic diagram that illustrates an overview of the generation of a moving image (consecutively photographed images) by performing high speed photographing according to an embodiment of the present invention. In FIG. 1, although a plurality of frames are present between frames illustrated in the figure, the plurality of frames will not be illustrated.

In this embodiment, a golf swing (hereinafter, simply referred to as a “swing”) is photographed using a high-speed camera capable of photographing 30 or more frame images per second and the photographed images are stored as a moving image.

More specifically, in a case where a person taking a swing will perform a photographing operation with himself as the photographing target, as illustrated in FIG. 1, by starting photographing, for example, from a state in which there is no ball, the person who will take a swing then places a ball and proceeds to take a swing, starting from address and ending with the finish. As a result, in a buffer area of a photographing apparatus, states starting from the state in which there is temporarily no ball and continuing to the state in which a photographing process ends are stored as a plurality of images.

In a normal photographing process, states starting from the state in which the photographing process starts and continuing to the state in which the photographing process ends, in other words, the states starting from the state in which there is no ball and continuing to the state in which the finish is performed and the photographing process has ended, are stored as a moving image.

However, in this embodiment, among the states from the state in which there is no ball to the state in which the finish is performed and the photographing process has ended, a moving image of address, which corresponds to the starting time point of a swing, and up to the finish, which corresponds to the ending time point of the swing, are stored. In other words, states before the address and after the finish are not employed as a moving image.

By configuring in such a manner, the moving image data amount can be reduced. In addition, a moving image is started with the address, which is in the starting time point of a swing, being set as an initial frame, and accordingly, when the moving image is reproduced, efforts to perform a search (loading) of the starting time point of the swing can be omitted. When a high speed photographing process other than the normal photographing process is performed, the reduced amount of data and the omission of the search at the time of reproducing a moving image are marked.

An image capture apparatus according to an embodiment of the present invention has a function for storing a moving image without storing a frame prior to the address posture when the high speed photographing process is performed for a swing, as described above.

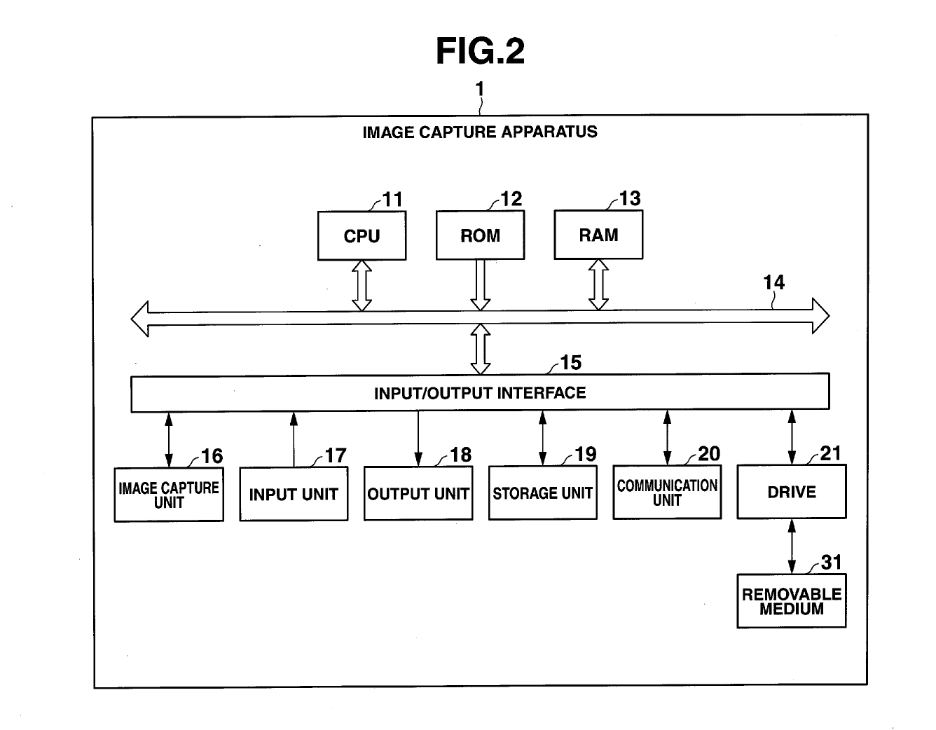

FIG. 2 is a block diagram that illustrates the hardware configuration of the image capture apparatus 1 having such a function.

The image capture apparatus 1, for example, is configured by a digital camera capable of performing a high speed photographing process.

The image capture apparatus 1, as illustrated in FIG. 2, is equipped with: a central processing unit (CPU) 11; a read only memory (ROM) 12; a random access memory (RAM) 13; a bus 14; an input/output interface 15; an image capture unit 16; an input unit 17; an output unit 18; a storage unit 19; a communication unit 20; and a drive 21.

The CPU 11 performs various processes in accordance with a program recorded in the ROM 12 or a program loaded from the storage unit 19 into the RAM 13.

In the RAM 13, data that is necessary for the CPU 11 to perform various processes and the like are appropriately stored.

The CPU 11, the ROM 12, and the RAM 13 are interconnected through the bus 14. In addition, the input/output interface 15 is connected to this bus 14. The image capture unit 16, the input unit 17, the output unit 18, the storage unit 19, the communication unit 20, and the drive 21 are connected to the input/output interface 15.

The image capture unit 16 is configured by a high speed camera and is configured to perform high-speed photographing capable of generating frame images exceeding 30 frames per second.

Although not illustrated in the figure, the image capture unit 16 is equipped with an optical lens unit and an image sensor.

The optical lens unit is configured by a lens that collects light, for example, a focusing lens or a zoom lens, in order to photograph a subject.

The focusing lens is a lens that forms a subject image on the light reception face of an image sensor. The zoom lens is a lens that freely changes a focal distance within a predetermined range.

In addition, in the optical lens unit, as is necessary, peripheral circuits that adjust setting parameters, such as the focus, the exposure, and the white balance, are provided.

The image sensor is configured by a photoelectric conversion device, an analog front end (AFE), or the like.

The photoelectric conversion device, for example, is configured by a photoelectric conversion device of the complementary metal oxide semiconductor (CMOS) type. A subject image enters, from the optical lens unit, the photoelectric conversion device. Then, the photoelectric conversion device performs photoelectric conversion (capturing) of the subject image, accumulates image signals for a predetermined time, and sequentially supplies the accumulated image signals to the AFE as analog signals.

The AFE performs various signal processes, such as an analog/digital (A/D) conversion process and the like for the analog image signals.

A digital signal is generated through the various signal processes, and is output as an output signal of the image capture unit 16. Hereinafter, the output signal of the image capture unit 16 will be referred to as “image data”. The image data is supplied to the CPU 11 and the like as the data of a captured image or the data of a frame image (hereinafter, also simply referred to as a “frame”) as is appropriate.

The input unit 17 is configured by various buttons and the like and inputs various kinds of information in accordance with a user's operation instructions.

The output unit 18 is configured by a display and a speaker, or the like, and outputs an image or a voice.

The storage unit 19 is configured by a hard disk, a dynamic random access memory (DRAM), or the like, and stores data of various images.

The communication unit 20 controls communication with the other devices (not illustrated in the figure) through networks, including the Internet.

In the drive 21, a removable medium 31 that is configured by a magnetic disk, an optical disc, a magneto-optical disk, or a semiconductor memory, is mounted as is appropriate. A program that is read out from the removable medium 31 by the drive 21 is installed to the storage unit 19 as is necessary. In addition, similar to the storage unit 19, the removable medium 31 can store various kinds of data, such as the image data stored in the storage unit 19, and the like.

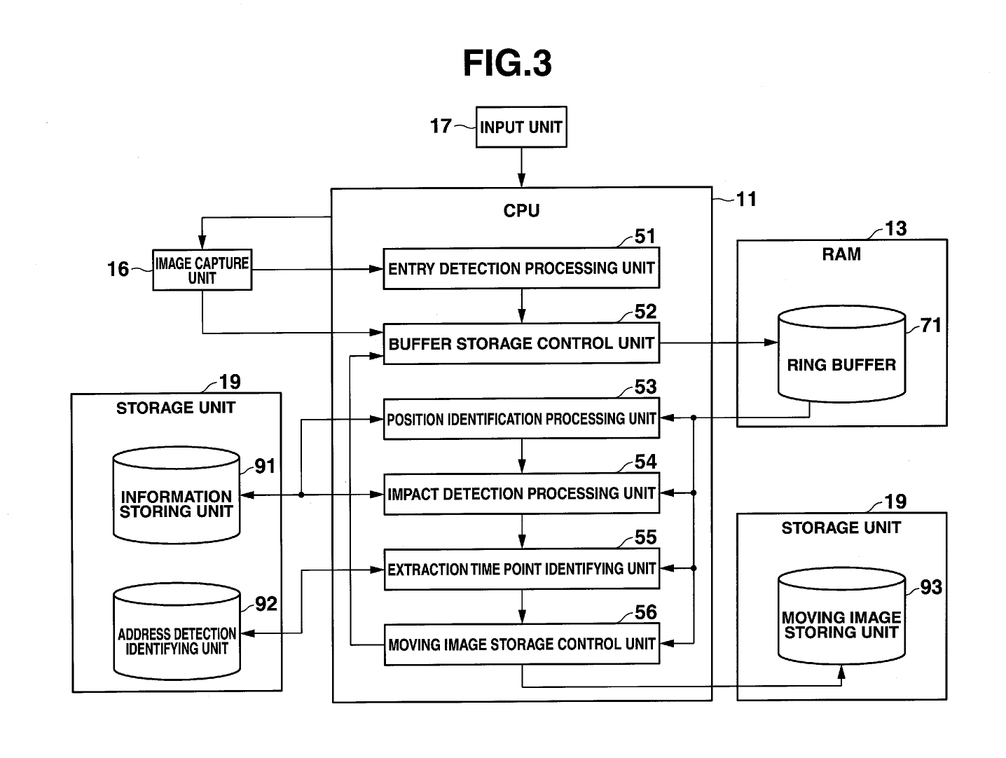

FIG. 3 is a functional block diagram that illustrates the functional configuration used for performing a swing moving image photographing process, among the functional configurations of the image capture apparatus 1.

Here, the “swing moving image photographing process” is the process from an address operation, which corresponds to the starting time point of a swing, to a series of swing operations performed thereafter to be extracted and stored as a moving image. During the swing moving image photographing process, captured images that have been captured are sequentially displayed in the output unit 18. The captured image displayed in the output unit 18 described here is called a “live view image”. The user views the display of the output unit 18, thereby checking the photographing position, the setting of an area frame to be described later, a ball detection result, and the like.

In a case where the swing moving image photographing process is performed, as illustrated in FIG. 3, in the CPU 11, an entry detection processing unit 51, a buffer storage control unit 52, a position identification processing unit 53, an impact detection processing unit 54, an extraction time point identifying unit 55, and a moving image storage control unit 56 function.

In one area of the RAM 13, a ring buffer 71 is arranged.

The ring buffer 71 has a data structure for performing the insertion/deletion of a lead element and a tail element at high speed, and, by cyclically designating the address using a write pointer and a read pointer, the data of frames is sequentially stored therein.

In one area of the storage unit 19, an information storing unit 91, an address detection identifying unit 92, and a moving image storing unit 93 are arranged.

In the information storing unit 91, information such as an image (hereinafter, referred to as a “template image”) that is used for template matching, which is employed in detecting swing posture, for example, address or impact, is stored. The information storing unit 91 will be described later in detail.

In the address detection identifying unit 92, detection information used for detecting address is stored. The address detection identifying unit 92 will be described in detail later.

In the moving image storing unit 93, data of a moving image is stored. The moving image storing unit 93 will be described in detail later.

The entry detection processing unit 51 performs an entry detecting process.

Here, the “entry detecting process” is a series of processes that occur until an image indicative of the entry of an object, such as a person, into a predetermined area of the area being photographed, is detected out of the images captured by the image capture unit 16. In this entry detecting process, more specifically, the entry of a player for placing a ball is detected.

In other words, the entry detection processing unit 51, for example, detects that a person taking a swing enters so as to place a ball by analyzing frames output from the image capture unit 16.

The buffer storage control unit 52 performs control, such that images captured by the image capture unit 16 are sequentially stored in the ring buffer 71 as frame data. From there, the storing of frame data in the ring buffer 71 is stopped.

The position identification processing unit 53 performs a ball position identifying process.

Here, the “ball position identifying process” is a series of processes performed until a frame in which a ball is present is detected from among a plurality of frames stored in the ring buffer 71, and the position of the ball in the frame is identified.

In other words, the position identification processing unit 53 detects a ball in a predetermined area of the photographed area of a frame from among the frames stored in the ring buffer 71, and determines the position of the area occupied by the ball that includes the center position of the detected ball.

The impact detection processing unit 54 performs an impact detecting process.

Here, the “impact detecting process” is a series of processes performed until it is determined whether there is a ball for which the position has been determined from among the frames stored in the ring buffer 71, and a frame at the impact is detected. In addition, in the “impact detecting process”, a process for determining the timing at which the ring buffer 71 is stopped is also included.

In other words, the impact detection processing unit 54 detects a frame from the impact of a person taking a swing from among the frames stored in the ring buffer 71.

The extraction time point identifying unit 55 performs an address detecting process as a process to detect an extraction time point.

Here, the “address detecting process” is a series of processes performed until a frame of the address is detected from the frames prior to detecting a frame of the impact from among the frames stored in the ring buffer 71.

In other words, the extraction time point identifying unit 55 detects a frame of the address which corresponds to a time point of extraction from the frames prior to detecting the frame of the impact from among the frames stored in the ring buffer 71. This is done by using the information for detection of the address detection identifying unit 92.

The moving image storage control unit 56 controls the moving image storing unit 93 such that a moving image configured by predetermined frames from a plurality of frames stored in the ring buffer 71 is stored.

More specifically, the moving image storage control unit 56 performs control of the moving image storing unit 93 such that a moving image between a frame following the frame of address detected by the extraction time point identifying unit 55 and a frame (a frame after the elapse of a predetermined time from the frame of the impact) of the finish, which is assumed based on the frame of the impact, is extracted and stored.

As above, out of the functional configurations of the image capture apparatus 1, the functional configuration for performing the swing moving image photographing process has been described.

Next, a functional configuration for performing an entry detecting process which is included in the swing moving image photographing process will be described.

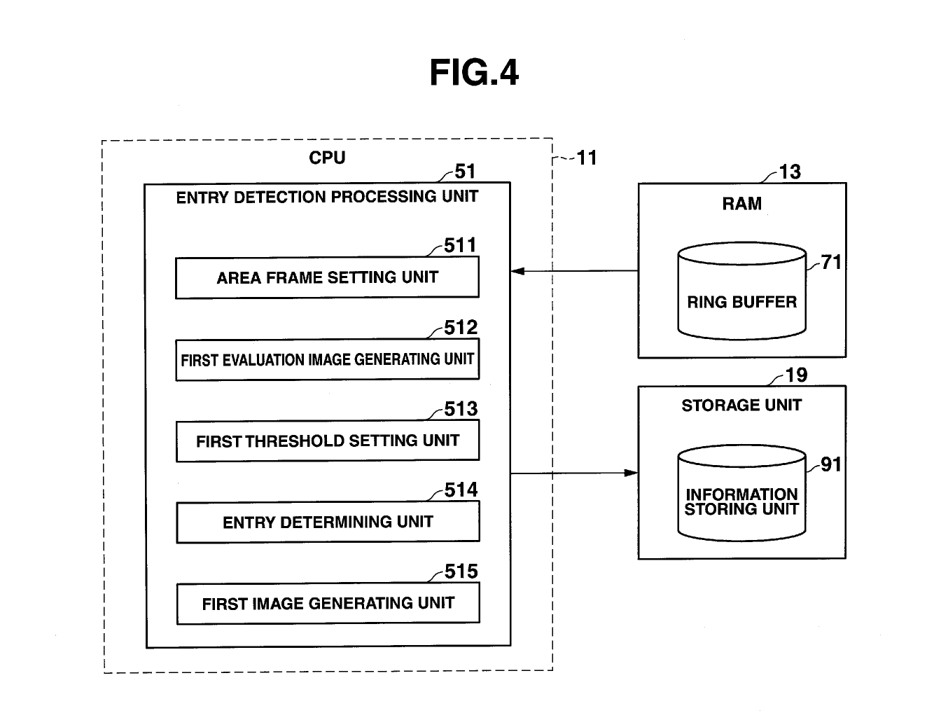

FIG. 4 is a functional block diagram that illustrates the functional configuration used for performing the entry detecting process which is included in the swing moving image photographing process.

In a case where the entry detecting process is performed, as illustrated in FIG. 4, in the entry detection processing unit 51, an area frame setting unit 511, a first evaluation image generating unit 512, a first threshold setting unit 513, an entry determining unit 514, and a first image generating unit 515 function.

The area frame setting unit 511 sets an area frame to a predetermined area of the photographing area. An area including the area in which a ball is predicted to be placed is set as the area frame.

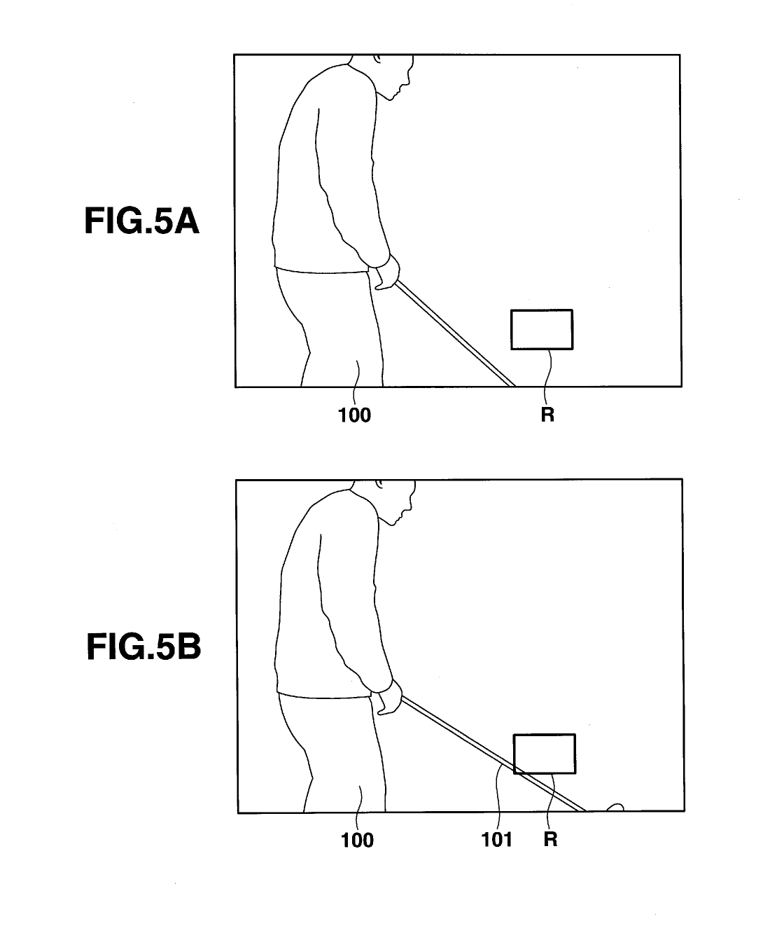

FIGS. 5A and 5B are schematic diagrams that illustrate entry detection, including the setting of the area frame R.

As illustrated in FIG. 5A, the area frame R, for example, is set to a place at which a ball is assumed to hit when the person 100 taking a swing stands at the swing position in a case where the person 100 taking the swing is photographed from behind. In this example, since the right-handed person 100 taking the swing is assumed to be positioned near the center of the photographing area, the area frame R is set below the center portion.

In addition, the area frame setting unit 511 may be configured to set a different area frame in accordance with the dominant hand of the person 100 taking the swing or the photographing direction, or, it may be configured to set the area frame R by a user's area frame setting operation for the input unit 17. In such a case, an arbitrary position may be set as the area frame R by the user.

The first evaluation image generating unit 512 generates an evaluation image (hereinafter, referred to as a “first evaluation image”) used for detecting entry into the set area frame. The first evaluation image is formed by a first-derivative edge image that is acquired by generating edge images from the original image and smoothing a plurality of the generated edge images in the time direction.

The first threshold setting unit 513 sets a first threshold used for detecting the presence of an entry in a frame based on changes in several frames in units of pixels. The first threshold is adaptively set by using several frames near the setting of the threshold so as not to be influenced by the photographing environment, including the time of day.

The entry determining unit 514 determines an entry into the area frame R. The entry determining unit 514 determines whether a difference between the value of each frame pixel that is a determination target and the value of each pixel of the first evaluation image exceeds the first threshold. In a case where the difference exceeds the first threshold, the entry determining unit 514 determines that there is an entry. On the other hand, in a case where the difference does not exceed the first threshold, the entry determining unit 514 determines that there is no entry.

Through the entry determination process, a frame that is in a state in which a club 101 has entered the area frame R when a person 100 taking a swing attempts to place a ball at a spot at which the ball should be placed within the area frame R as illustrated in FIG. 5B is detected.

The first image generating unit 515 generates a template image (hereinafter, referred to as a “first template image”) that is employed in detecting the impact using a frame image immediately after the determination of the presence of an entry. The first template image is an image that is in a state in which there is no ball within the area frame. In this embodiment, in consideration of the robustness, the frame image immediately following the detection of an entry is used as the first template image.

Thereafter, the first image generating unit 515 stores the first template image in the information storing unit 91.

As above, the functional configuration used for performing the entry detecting process which is included in the swing moving image photographing process, has been described.

Next, a functional configuration used for performing the ball position identifying process which is included in the swing moving image photographing process will be described.

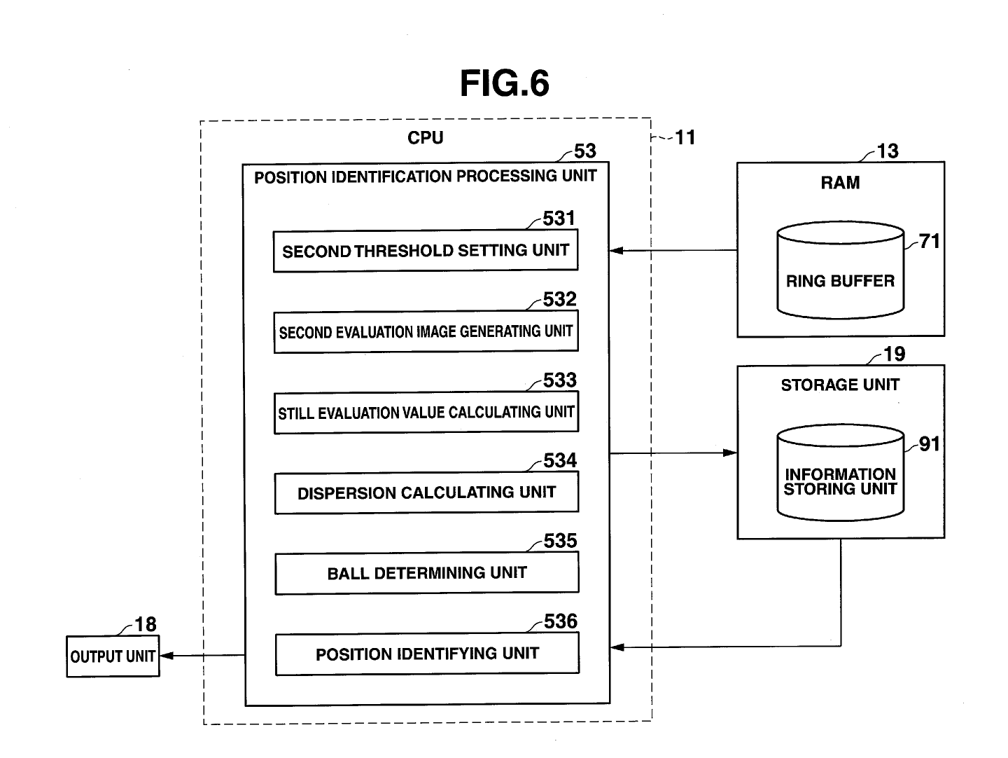

FIG. 6 is a functional block diagram that illustrates the functional configuration used for performing the ball position identifying process included in the swing moving image photographing process.

In a case where the ball position identifying process is performed, as illustrated in FIG. 6, in the position identification processing unit 53, a second threshold setting unit 531, a second evaluation image generating unit 532, a still evaluation value calculating unit 533, a dispersion calculating unit 534, a ball determining unit 535, and a position identifying unit 536 function.

The second threshold setting unit 531 sets a second threshold for ball detection that is used for detecting the presence of an entry in a frame based on changes in several frames before the detection of the entry in units of pixels. The second threshold is adaptively set by using several frames near the setting of the threshold so as not to be influenced by a photographing environment such as the time of day.

The second evaluation image generating unit 532 generates an evaluation image (hereinafter, referred to as a “second evaluation image”) that is used for detecting a ball in the area frame. The second evaluation image is formed by a first-derivative edge image that is acquired by generating edge images from the original image and subsequently smoothing a plurality of the generated edge images in the time direction.

In order to determine the still state of an object that occupies a predetermined area, the still evaluation value calculating unit 533 counts the number of pixels of the second evaluation image that meet the second threshold or exceed it, and then calculates a still evaluation value.

The dispersion calculating unit 534 calculates an average coordinate value from the coordinate values (luminance values in this embodiment) of pixels of the second evaluation image that meet the second threshold or exceed it. Then, the dispersion calculating unit 534 calculates a dispersion evaluation value of the local area which has the calculated average coordinate value as its center. Accordingly, the question of whether a ball and other objects are present within the area frame can be calculated in units of pixels.

The ball determining unit 535 determines whether only a ball is present based on the dispersion evaluation value calculated by the dispersion calculating unit 534. This is done by using the still evaluation value calculated with reference to the still evaluation value calculating unit 533. In other words, the ball determining unit 535 determines whether the inside of the area is in the still state based on the still evaluation value and determines whether the dispersion evaluation value is within a predetermined range to be in a state in which only a ball is present.

In addition, the ball determining unit 535 further determines whether the state in which only a ball is present is formed for a predetermined time. In other words, the ball determining unit 535 determines whether the inside of the area is in the still state based on the still evaluation value and further determines whether the dispersion evaluation value is within a predetermined range to be in the state in which only a ball is present for a predetermined time.

The position identifying unit 536 calculates the coordinates of the ball based on the average coordinates calculated within the local area. Then, the position identifying unit 536 identifies the position of the ball by the calculated coordinates of the ball. At this time, the position identifying unit 536 updates the ball position information stored in the information storing unit 91 and performs a highlighted display of the identified ball together with a live view image in the output unit 18.

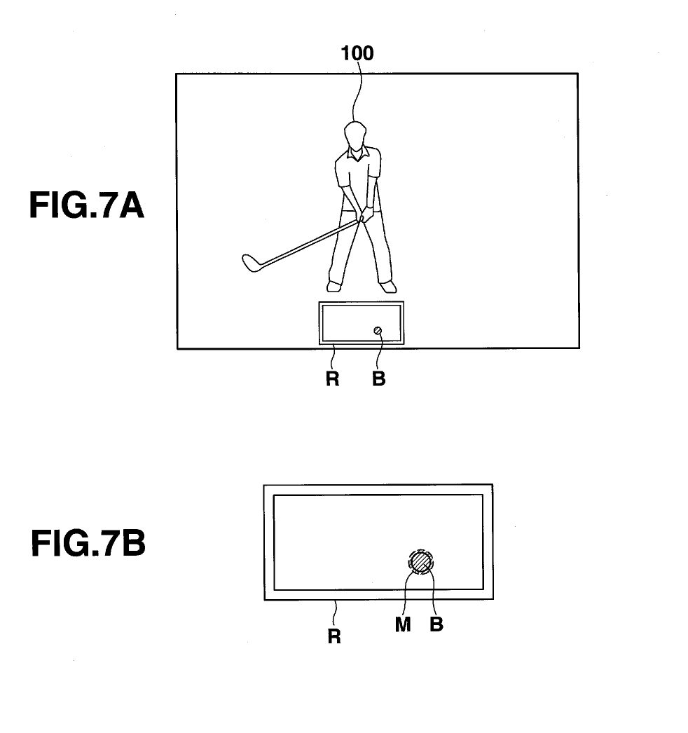

FIGS. 7A and 7B are schematic diagrams that illustrate a result of identifying the ball position. FIGS. 7A and 7B indicate an example of a case where a person 100 taking a swing is photographed from the anterior.

The example in FIG. 7A illustrates a state in which a ball B is placed in an area frame R, immediately prior to the person who is to take a swing 100 swinging at the ball. In such a state, the identification of the position of the ball is started in accordance with the entry of the ball into the area frame R and is performed by determining that the ball occupies a predetermined area of the area frame R and that it is placed in a still area.

In a case where the position of the ball B is identified, as illustrated in FIG. 7B, in the output unit 18, a mark M which is used for highlighted display is displayed on the ball disposed within the area frame R in an overlapping manner together with a live view. The user can check that the position of the ball B is identified by checking the mark M.

As above, the functional configuration used for performing the ball position identifying process which is included in the swing moving image photographing process has been described.

Next, a functional configuration used for performing an impact detecting process which is included in the swing moving image photographing process, will be described.

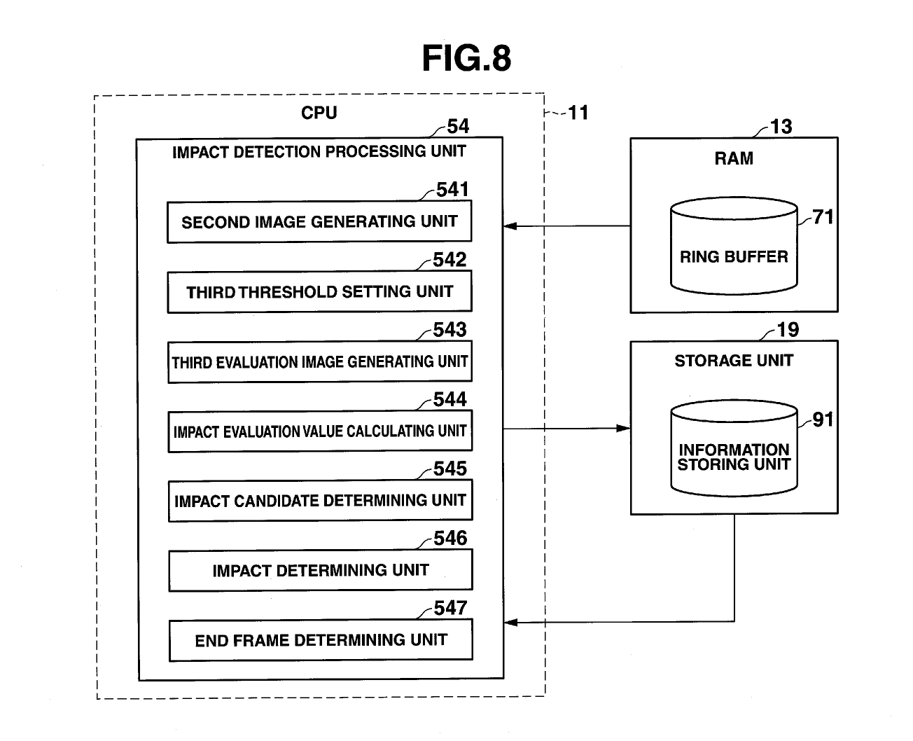

FIG. 8 is a functional block diagram that illustrates the functional configuration used for performing the impact detecting process which is included in the swing moving image photographing process.

In a case where the impact detecting process is performed, as illustrated in FIG. 8, in the impact detection processing unit 54, a second image generating unit 541, an impact threshold setting unit 542, an impact evaluation image generating unit 543, an impact evaluation value calculating unit 544, an impact candidate determining unit 545, an impact determining unit 546, and an end frame determining unit 547 function.

The second image generating unit 541 generates a frame image immediately after determining the presence of a ball as a template image (hereinafter, referred to as a “second template image”) which is used for detecting an impact. The second template image is an image in a state in which there is a ball within the area frame. In this embodiment, in consideration of the robustness, the frame immediately following the detection of the ball is used as the second template image.

Thereafter, the second image generating unit 541 stores the second temperate image in the information storing unit 91.

The impact threshold setting unit 542 sets a second threshold that is used for detecting an impact based on the first template image and the second template image.

For the second threshold, a difference value between the first and second template images is used. Since the second threshold is determined based on the first and second template images of the previous process, the second threshold is set in an adaptable manner.

The impact evaluation image generating unit 543 generates an evaluation image (hereinafter, referred to as a “third evaluation image”) which is used for detecting an impact. The third evaluation image is formed by an image (hereinafter, referred to as a “first differential image”) which is acquired by taking a difference between frames and a differential image (hereinafter, referred to as a “second differential image”) among the second template image and the frame images.

The impact evaluation value calculating unit 544 calculates an evaluation value (hereinafter, referred to as a “first evaluation value”) of the first differential image and an evaluation value (hereinafter, referred to as a “second evaluation value”) of the second differential image in the impact detection area that is within the coordinates (within the ball frame) at which the ball is positioned. Hereinafter, the first evaluation value and the second evaluation value will be collectively referred to as “impact evaluation values”.

The impact candidate determining unit 545 performs a determination process for detecting the moment of an impact at which the evaluation value rapidly changes. In other words, the impact candidate determining unit 545 determines whether the first and second evaluation values meet the third threshold or exceed it. In such case, where both the first and second evaluation values are determined to meet the third threshold or exceed it, the impact candidate determining unit 545 determines that there is detection of an impact.

The impact determining unit 546 detects a peculiar state occurring after an impact in which a change in the first evaluation value disappears, and the second evaluation value continues to be a predetermined value or more. In other words, the impact determining unit 546 determines whether the first evaluation value meets the third threshold or is less, whether the second evaluation value meets the third threshold or exceeds it, and the state of meeting the third threshold or exceeding it is continued for a predetermined period. In this case, where the first evaluation value meets the third threshold or is less, the second evaluation value meets the third threshold or exceeds it, and the state of meeting the third threshold or exceeding it is continued for the predetermined period, the impact determining unit 546 detects that there has been an impact.

Here, the determination of an impact will be described.

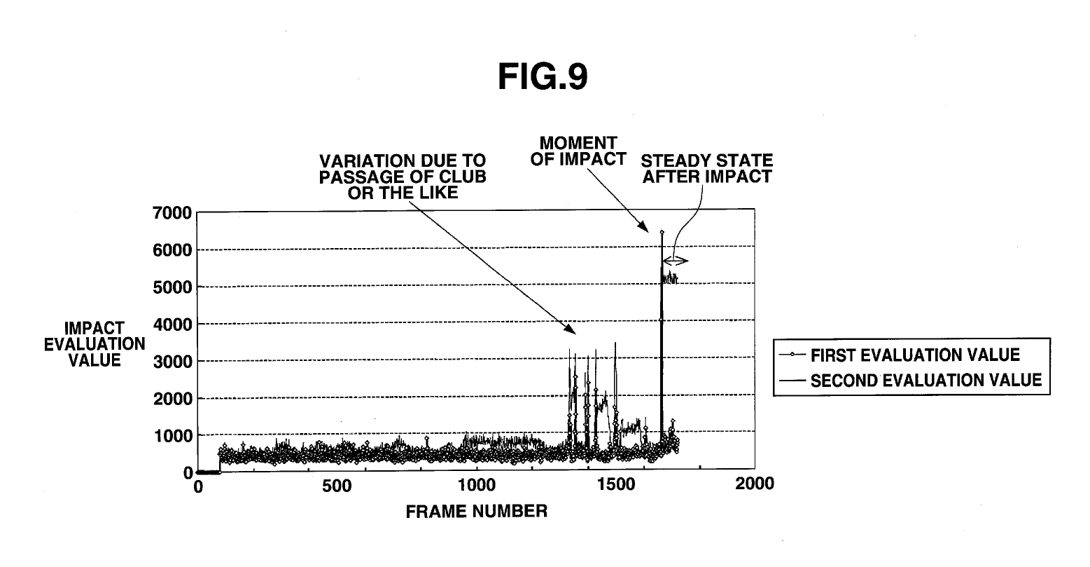

FIG. 9 is a graph that illustrates an example of variations in the impact evaluation value around an impact. In FIG. 9, the horizontal axis indicates the frame number, and the vertical axis indicates the value of the impact evaluation value. In addition, line a indicates the first evaluation value, and line b indicates the second evaluation value.

As illustrated in the example indicated in FIG. 9, within the area frame, in a case where there is no passage of a club or the like within the area frame, there is no variation in the impact evaluation value (the frame number: near 0 to 1,300, and the impact evaluation value: near 0 to 1,000). On the other hand, in a case where there is the passage of a club or the like, there is a variation in the impact evaluation value (the frame number: near 1,300 to 1,600, and the impact evaluation value: near 1,000 to 3,000). In this case, since the ball has stopped within the area frame, the width of the variation is small.

Thereafter, in a case where there is an impact (at the moment of the impact), the impact evaluation value changes sharply (near frame 1,650, the impact evaluation value rises to near 6,000). Thereafter, the impact evaluation value is in the steady state (after frame near 1,650, the impact evaluation value is stable near 5,000). Described in more detail, in a case where there is an impact (at the moment of the impact), the first and second evaluation values sharply rise (for example, to 4,500 or more). Then, immediately after the impact, a state is formed in which the second evaluation value is continuously maintained in order for it to be in the state of being a predetermined value or greater (for example, a second evaluation value of 4,500 or more is continued for 100 frames).

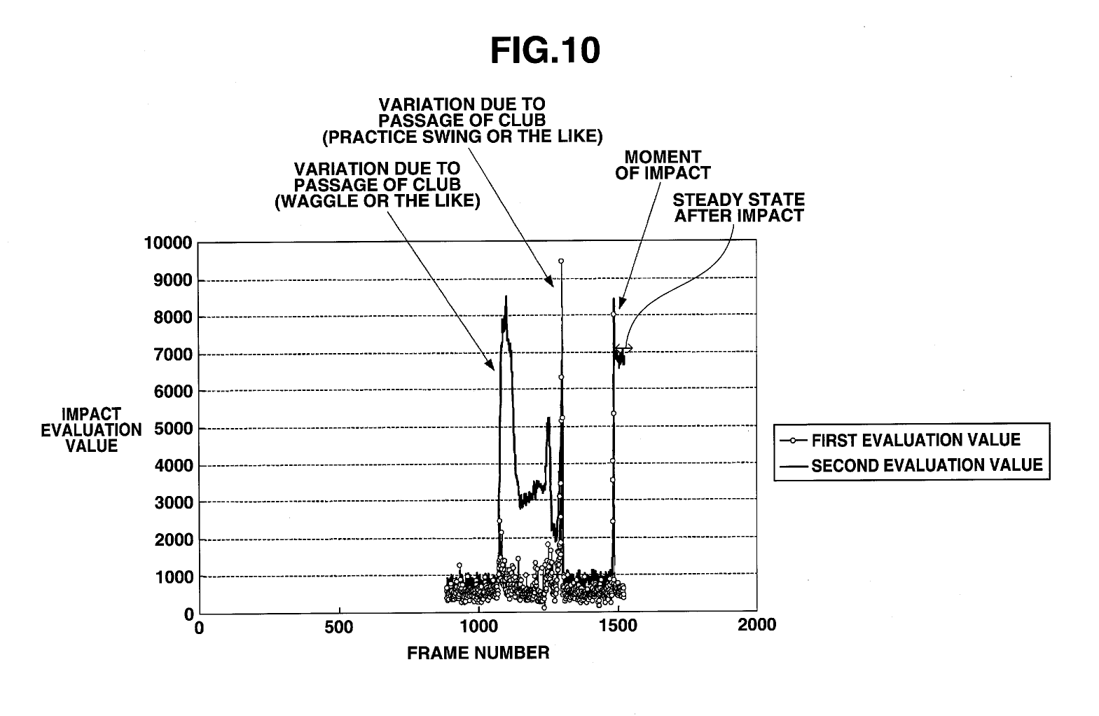

FIG. 10 is a graph that illustrates another example of the variations in the impact evaluation value around an impact. In FIG. 10, similar to FIG. 9, the horizontal axis indicates the frame number, and the vertical axis indicates the impact evaluation value. In addition, line a indicates the first evaluation value, and line b indicates the second evaluation value.

In the example in FIG. 10, since there are many states of passing through the inside of the area frame due to a waggle, or a practice swing and the like, although the variation is different from that of the example in FIG. 9, the state at the moment of an impact and the state immediately after the impact follow similar variations. More specifically, in a case where there is an impact (at the moment of an impact), the impact evaluation value changes sharply (rises to near an impact evaluation value of 8,000 near frame number 1,500) and then, it is in the steady state (stabilizes to be near an impact evaluation value of 7,000 after a frame number near 1,500). More specifically, in a case where there is an impact, the first and second evaluation values rise sharply (for example, to 4,500 or more). Then, right after the impact, a state is formed in which the second evaluation value is continuously maintained to be in a state of meeting a predetermined value or exceeding it (for example, a second evaluation value of 4,500 or greater is continued for 100 frames).

As illustrated in the examples in FIGS. 9 and 10, in a portion other than an impact, there are various variations in accordance with an entry into the area frame, and there is regularity of variations at the moment of the impact and immediately after the impact. Accordingly, in a case where a determination of an impact is performed, a variation in the impact evaluation value, which satisfies the regularity, may be determined.

In the determination of an impact, first, a variation at the moment of an impact is determined, and second, a variation immediately after the impact is determined.

As the variation at the moment of an impact for the first determination, it is determined whether both the first and second evaluation values meet the third threshold or exceed it.

In addition, as the variation immediately after the impact for the second determination, it is determined whether the first evaluation value meets the third threshold or is less, whether the second evaluation value meets the third threshold or exceeds it, and whether the state of meeting the third threshold or exceeding it is continued for a predetermined time.

The end frame determining unit 547 determines a frame after the elapse of a predetermined frame (time) from the frame in which the impact has been detected as the end frame which is the last frame stored as a moving image.

As above, the functional configuration used for performing the impact detecting process which is included in the swing moving image photographing process has been described.

Next, a functional configuration used for performing an address detecting process which is included in the swing moving image photographing process will be described.

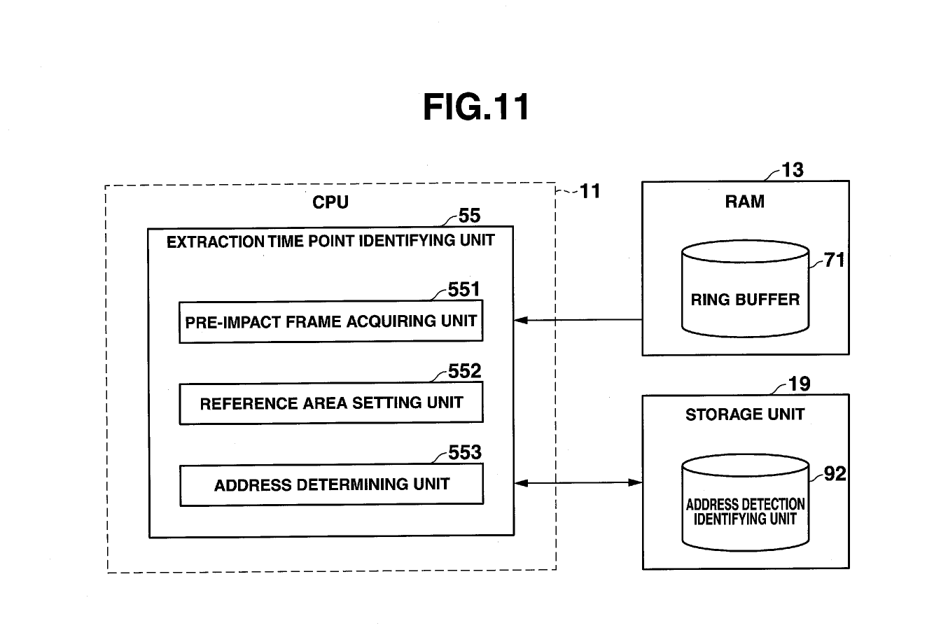

FIG. 11 is a functional block diagram that illustrates the functional configuration used for performing the address detecting process which is included in the swing moving image photographing process.

In a case where the address detecting process is performed, as illustrated in FIG. 11, in the extraction time point identifying unit 55, a pre-impact frame acquiring unit 551, a reference area setting unit 552, and an address determining unit 553 function.

In one area of the storage unit 19, an address detection identifying unit 92 is provided.

The address detection identifying unit 92 is constructed, for example, through mechanical learning according to histograms of oriented gradients (HOG) characteristic amounts and adaptive boosting (AdaBoost) by using a positive sample including an image data group of address postures and a negative sample that is an image data group of postures other than the address postures as learning samples. Described in more detail, the address detection identifying unit 92 is a strong identification unit constructed by constructing a weak identification unit by calculating HOG characteristic amounts that are characteristics of the edge-directional histogram of image data of each of the positive sample and the negative sample and weighting the weak identification unit that was constructed.

Here, the “positive sample” includes image data of address postures of golf swings of a variety of persons. In addition, the “negative sample”, aside from including image data not including any person, also includes image data of persons who are not in address postures. By performing mechanical learning using such learning samples, the strong identification unit which is capable of identifying a posture with higher precision as the posture is closer to an address posture can be formed.

The pre-impact frame acquiring unit 551 acquires frames prior to the frame in which an impact has been detected from the ring buffer 71.

The reference area setting unit 552 sets a reference area that has a predetermined size and includes a person who is taking a swing within the frame acquired by the pre-impact frame acquiring unit 551.

Here, in this embodiment, the “reference area” is an area that encloses a user who is in the address posture and a golf ball.

The address determining unit 553 determines the frame that has the highest characteristic amount in the reference area among the frames prior to the impact as a frame at the time of taking the address by using the address detection identifying unit 92.

More specifically, the address determining unit 553 determines whether each one of the frames prior to the impact is a frame of an address posture by using the address detection identifying unit 92 in the order of a time series. As a result, a frame having the highest output is detected as a frame of the address posture.

Although an impact posture and an address posture are postures that are very similar to each other, as described above, by detecting a frame of the address posture from the frames prior to the impact, an incorrect detection of the frame of the impact posture as a frame of an address posture is prevented, thereby allowing for the performance of higher precision address detection.

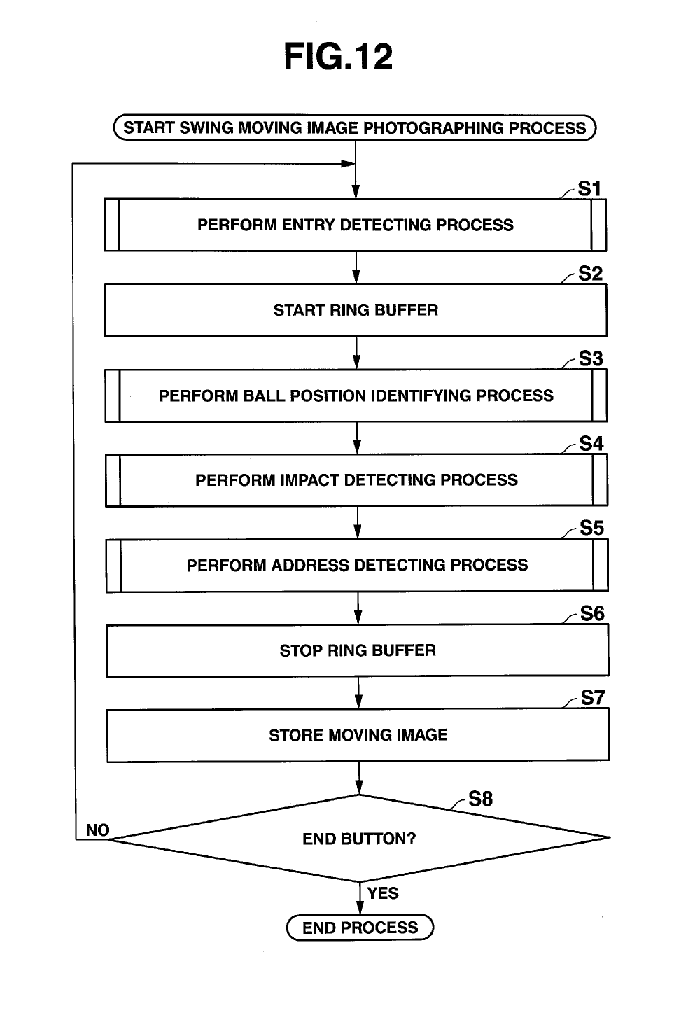

FIG. 12 is a flowchart that illustrates the flow of the swing moving image photographing process which is performed by the image capture apparatus 1 having the functional configuration illustrated in FIG. 3.

The swing moving image photographing process is started by being triggered upon a user's predetermined operation which is used for giving an instruction for starting the swing moving image photographing process for the input unit 17.

In Step S1, the entry detection processing unit 51 performs the entry detecting process. In other words, the entry detection processing unit 51 detects the entry of an object, such as a person, in the photographing area, which, for example, occurs when a player enters to place a ball.

In Step S2, the buffer storage control unit 52 starts the ring buffer 71. In other words, the buffer storage control unit 52 performs control of the ring buffer 71 to store the data of frames forming a moving image. Accordingly, recording is started.

In Step S3, the position identification processing unit 53 performs the ball position identifying process. In the ball position identifying process, in the case where there is a ball, the position identification processing unit 53 detects whether there is a ball in a frame and determines the position of the ball (the coordinates of the center position of the ball) in the frame.

In Step S4, the impact detection processing unit 54 performs the impact detecting process. In the impact detecting process, the impact detection processing unit 54 detects an impact by identifying a frame of an impact among the frames of the ring buffer 71. In addition, by performing the detection of an impact, the ending time point of the swing is determined. In this embodiment, a frame after the elapse of a predetermined time from the frame in which the impact has been detected is set as the ending time point of the swing.

In Step S5, the extraction time point identifying unit 55 performs the address detecting process. In the address detecting process, a frame of an address posture is identified, from among the frames prior to the frame in which the impact has been detected by the impact detection processing unit 54, for detecting the address posture.

In Step S6, upon the incoming of a frame of the ending time point of a swing, the buffer storage control unit 52 stops the ring buffer 71. In other words, the buffer storage control unit 52 controls the ring buffer 71 in order to stop the storing of data of frames forming a moving image. Accordingly, the recording process ends.

In Step S7, the moving image storage control unit 56 stores the moving image. In other words, the moving image storage control unit 56 performs control of the moving image storing unit 72 to extract and store the frames between the starting time point and the ending time point from frames stored in the ring buffer 71 as a moving image.

In Step S8, it is detected whether there is a user's operation of an end button for the input unit 17.

In a case where there is no operation of the end button, “No” is determined in Step S8, and the process is returned to Step S1. Thereafter, the process of Step S1 and subsequent steps are performed. In other words, until an operation of the end button is performed, the detection of an entry, the photographing of a swing, and the storing of a moving image are repeated.

On the other hand, in a case where there is an operation of the end button, “Yes” is determined in Step S8, and the swing moving image photographing process ends.

As above, the flow of the swing moving image photographing process has been described.

Next, a detailed flow of the entry detecting process which is included in the swing moving image photographing process will be described.

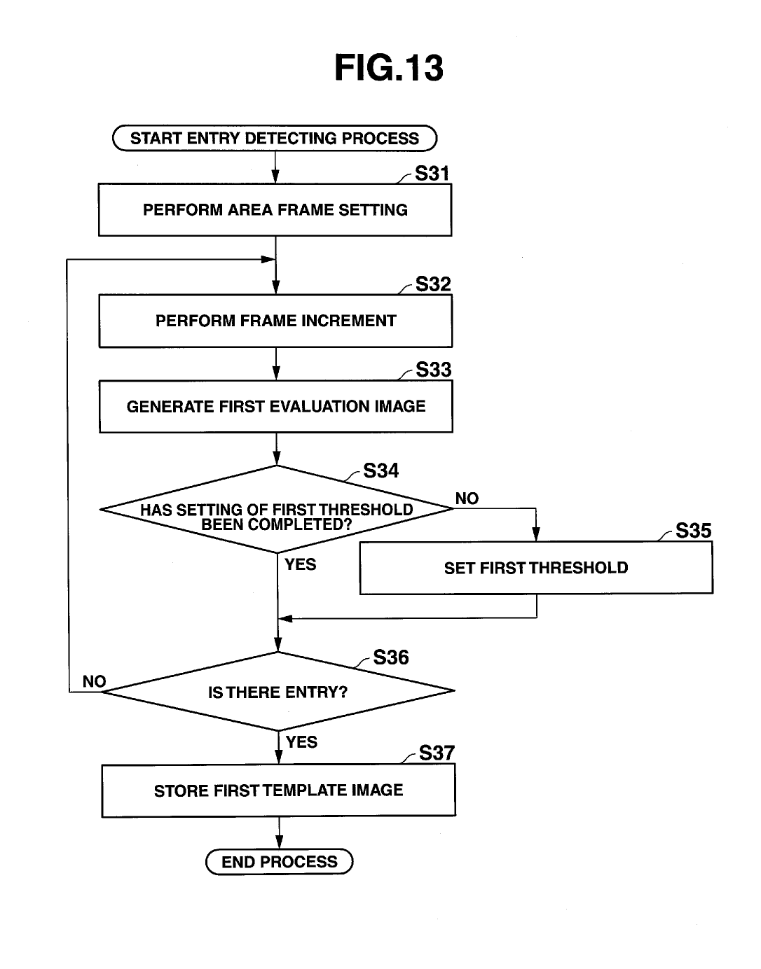

FIG. 13 is a flowchart that illustrates the detailed flow of the entry detecting process which is included in the swing moving image photographing process that is performed by the image capture apparatus 1 having the functional configuration illustrated in FIG. 4.

The entry detecting process is started by being triggered upon a user's predetermined operation which is used for giving an instruction for starting the entry detecting process of the input unit 17.

In Step S31, the area frame setting unit 511 sets an area frame in a predetermined area of the photographing area. For example, the area frame, as illustrated in FIG. 7A, is an area of the photographing area in which a ball is predicted to be placed.

In Step S32, the entry detection processing unit 51 increments the frame number. In other words, the entry detection processing unit 51 performs a frame updating process.

In Step S33, the first evaluation image generating unit 512 generates the first evaluation image that is used for detecting an entry. More specifically, the first evaluation image generating unit 512 generates the first-derivative edge image that is acquired by generating edge images from the original image and smoothing a plurality of the generated edge images in the time direction as the first evaluation image.

In Step S34, the first threshold setting unit 513 determines whether the setting of the first threshold has been completed.

In a case where the setting of the first threshold has been completed, “Yes” is determined in Step S34, and the process proceeds to Step S36. The process of Step S36 and subsequent steps will be described later.

On the other hand, in a case where the setting of the first threshold has not been completed, “No” is determined in Step S34, and the process proceeds to Step S35.

In Step S35, the first threshold setting unit 513 sets the first threshold for all the pixels disposed within the area frame based on the changes in several frames, in units of pixels.

In Step S36, the entry determining unit 514 performs an entry determination. In other words, the entry determining unit 514 determines whether a frame, which is a determination target, exceeds the first threshold determined by the first threshold setting unit 513. In a case where the frame exceeds the first threshold, the entry determining unit 514 determines that there has been an entry. On the other hand, in a case where the frame does not exceed the first threshold, the entry determining unit 514 determines that there is no entry. Described in more detail, the determination of an entry is performed based on whether pixels of the frame that correspond to a predetermined number exceed the respective thresholds determined for the pixels.

In a case where there is no entry, “No” is determined in Step S36, and the process is returned to Step S32. Thereafter, the process of Step S32 and subsequent steps are performed.

On the other hand, in a case where there is an entry, “Yes” is determined in Step S36, and the process proceeds to Step S37.

In Step S37, the first image generating unit 515 stores the first template image in the information storing unit 91. By setting the image in which the entry has been detected as the first template image for impact detection, the robustness can be improved.

Thereafter, the entry detecting process ends.

As above, the detailed flow of the entry detecting process which is included in the swing moving image photographing process has been described.

Next, a detailed flow of the ball position identifying process which is included in the swing moving image photographing process will be described.

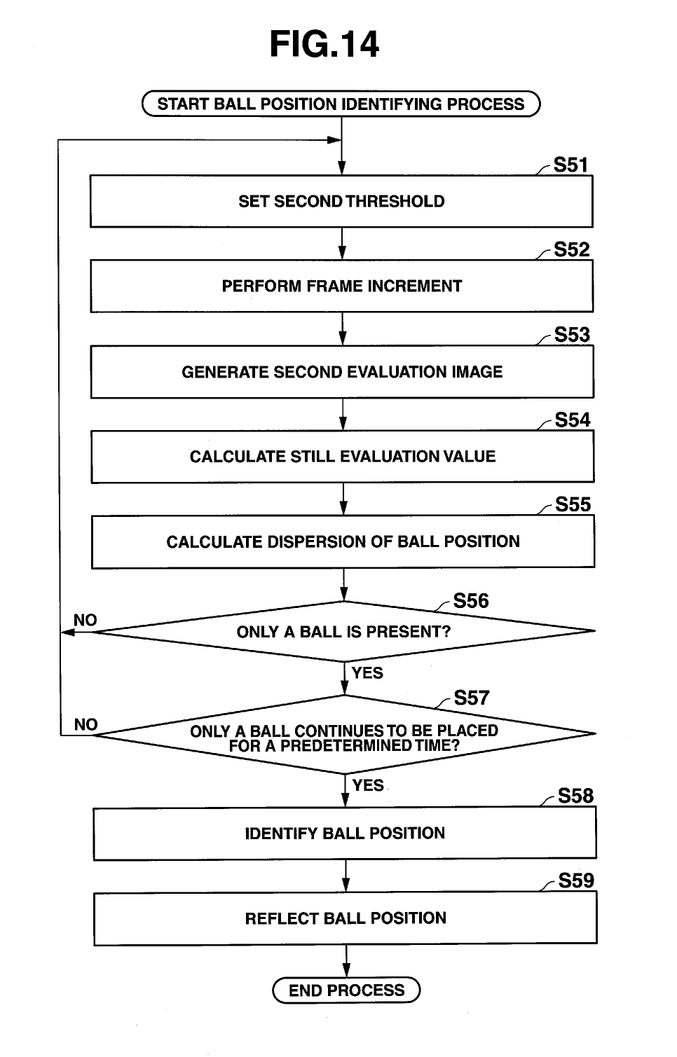

FIG. 14 is a flowchart that illustrates the detailed flow of the ball position identifying process which is included in the swing moving image photographing process performed by the image capture apparatus 1 having the functional configuration illustrated in FIG. 6.

The ball position identifying process is started by being triggered upon a user's predetermined operation which is used for giving an instruction for starting the ball position identifying process for the input unit 17.

In Step S51, the second threshold setting unit 531 sets a first threshold for all the pixels disposed within the area frame based on changes in several frames prior to the detection of an entry in units of pixels.

In Step S52, the position identification processing unit 53 performs a frame increment. In other words, the position identification processing unit 53 performs a frame updating process.

In Step S53, the second evaluation image generating unit 532 generates a second evaluation image that is used for detecting a ball. More specifically, the second evaluation image generating unit 532 generates a first-derivative edge image that is acquired by generating edge images from the original image and smoothing a plurality of the generated edge images in the time direction as the second evaluation image.

In Step S54, the still evaluation value calculating unit 533 calculates a still evaluation value. Described in more detail, the still evaluation value calculating unit 533 counts the number of pixels of the second evaluation image having the second threshold or more and calculates a still evaluation value.

In Step S55, the dispersion calculating unit 534 calculates a dispersion evaluation value. Described in more detail, the dispersion calculating unit 534 calculates an average coordinate value from the coordinate values of pixels meeting the second threshold or exceeding it and also calculates a dispersion evaluation value in a local area that has the calculated average coordinate value as its center.

In Step S56, the ball determining unit 535 determines whether only a ball is present. In other words, the ball determining unit 535 determines whether the inside of the area is in the still state based on the still evaluation value and further determines whether the state is formed in which the dispersion evaluation value is within a predetermined range, and whether only a ball is present.

In a case where there is no ball or in a case where there is any object other than a ball, “No” is determined in Step S56, and the process is returned to Step S51. Thereafter, the process of Step S51 and subsequent steps are performed.

On the other hand, in a case where only a ball is present, “Yes” is determined in Step S56, and the process proceeds to Step S57.

In Step S57, the ball determining unit 535 performs a state continuation determination for further determining the state in which only a ball continues to be placed for a predetermined time.

In a case where the state in which only a ball is placed for a predetermined time is not formed, “No” is determined in Step S57, and the process is returned to Step S51. Thereafter, the process of Step S51 and subsequent steps are performed.

On the other hand, in a case where the state in which only a ball is placed for a predetermined time is formed, “Yes” is determined in Step S57, and the process proceeds to Step S58.

In Step S58, the position identifying unit 536 identifies the position of the ball. In other words, the position identifying unit 536 calculates the coordinates of the ball based on the average coordinates calculated within the local area and identifies the coordinates of the ball as the position of the ball.

In Step S59, the position identifying unit 536 reflects the position of the ball. In other words, the position identifying unit 536 performs an updated display of the ball position information. In other words, the position identifying unit 536 updates the ball position information stored in the information storing unit 91 and displays the ball to overlap the live view image so as to schematically display the position of the ball in the output unit 18. Thereafter, the ball position identifying process ends.

More specifically, as illustrated in FIG. 7B, a mark M is displayed to overlap the ball B displayed in the live view image within the area frame R of the output unit 18.

As above, the detailed flow of the ball position identifying process which is included in the swing moving image photographing process has been described.

Next, a detailed flow of the impact detecting process which is included in the swing moving image photographing process will be described.

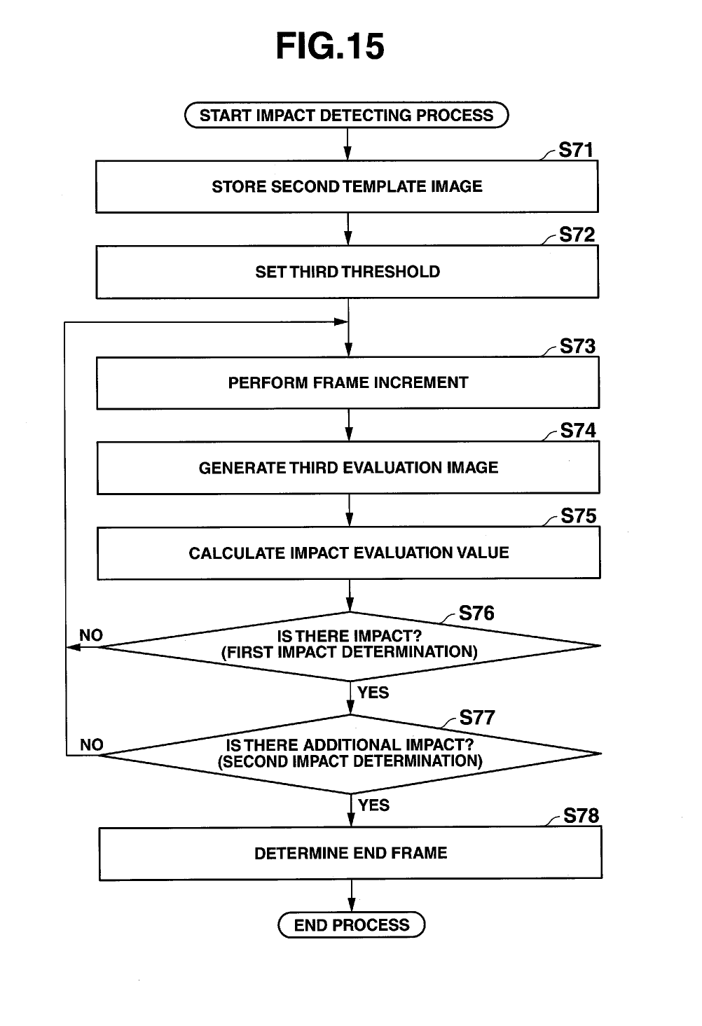

FIG. 15 is a flowchart that illustrates the detailed flow of the impact detecting process which is included in the swing moving image photographing process that is performed by the image capture apparatus 1 having the functional configuration illustrated in FIG. 8.

The impact detecting process is started by being triggered upon a user's predetermined operation which is used for giving an instruction for starting the impact detecting process of the input unit 17.

In Step S71, the second image generating unit 541 stores the second template image in the information storing unit 91.

In Step S72, the impact threshold setting unit 542 sets a third threshold based on the first template image and the second template image.

In Step S73, the impact detection processing unit 54 performs a frame increment. In other words, the impact detection processing unit 54 performs a frame updating process.

In Step S74, the impact evaluation image generating unit 543 generates a third evaluation image (the first differential image and the second differential image).

In Step S75, the impact evaluation value calculating unit 544 calculates the impact evaluation values (the first evaluation value and the second evaluation value).

In Step S76, the impact candidate determining unit 545 determines whether there is a candidate for an impact (impact candidate determination). In other words, the impact candidate determining unit 545 determines whether both the first and second evaluation values meet the second threshold or exceed it. Here, the moment of the impact is determined. More specifically, as illustrated in the example indicated in FIG. 9, it is determined that there is a first impact near frame number 1,650.

In addition, in the example indicated in FIG. 10 that illustrates another variation, it is determined that there are first impacts near frame number 1,100, frame number 1,300, and frame number 1,500.

In a case where there is no impact, “No” is determined in Step S76, and the process is returned to Step S73. Thereafter, the process of Step S73 and subsequent steps are performed.

On the other hand, in a case where there is an impact, “Yes” is determined in Step S76, and the process proceeds to Step S77.

In Step S77, the impact determining unit 546 determines whether the candidate for the impact is an actual impact (impact determination). In other words, the impact determining unit 546 determines whether the first evaluation value meets the third threshold or is less, whether the second evaluation value meets the third threshold or exceeds it, and whether the state of meeting the third threshold or exceeding it is continued for a predetermined period. Here, a steady state after the impact is determined.

More specifically, in the example in FIG. 9, it is determined that there is an impact near frame number 1,650 and thereafter. In addition, in the example in FIG. 10 that illustrates another variation, it is determined that there is an impact near frame number 1,500 and thereafter.

Accordingly, as a finally detected impact, in the example in FIG. 9, there is an impact near frame number 1,650 which is determined to be an actual impact in the impact candidate determination and the impact determination, and, in the example in FIG. 10, there is an impact near frame number 1,500.

In a case where there is no impact, “No” is determined in Step S77, and the process returns to Step S73. Thereafter, the process of Step S73 and subsequent steps are performed.

On the other hand, in a case where there is an additional impact, “Yes” is determined in Step S77, and the process proceeds to Step S78.

In Step S78, the end frame determining unit 547 determines a frame after a predetermined number of frames (after the elapse of a predetermined time) from the detected impact as an end frame. Thereafter, the impact detecting process ends.

As above, the detailed flow of the impact detecting process which is included in the swing moving image photographing process has been described.

Next, a detailed flow of the address detecting process which is included in the swing moving image photographing process will be described.

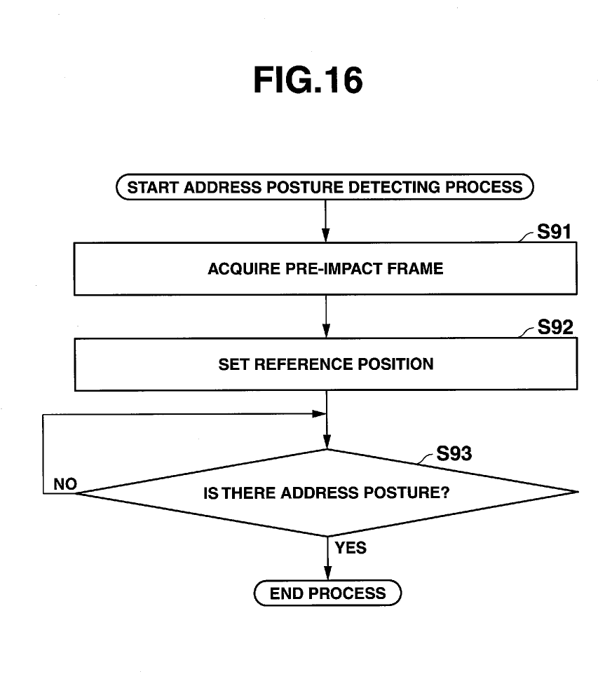

FIG. 16 is a flowchart that illustrates the detailed flow of the address detecting process which is included in the swing moving image photographing process that is performed by the image capture apparatus 1 having the functional configuration illustrated in FIG. 11.

The address detecting process is started by being triggered upon a user's predetermined operation which is used for giving an instruction for starting the address detecting process for the input unit 17.

In Step S91, the pre-impact frame acquiring unit 551 acquires frames prior to the frame in which the impact is detected from the ring buffer 71.

In Step S92, the reference area setting unit 552 sets a reference area of a predetermined size which includes the person taking a swing within the frame acquired by the pre-impact frame acquiring unit 551.

In Step S93, the address determining unit 553 determines whether there has been an address posture. In other words, the address determining unit 553 determines a frame that has the highest characteristic amount in the reference area among the frames prior to the impact as a frame at the time of addressing, by using the address detection identifying unit 92.

In a case where there is no address posture, “No” is determined in Step S93, and a determination is made for each frame until there is an address posture.

On the other hand, in a case where there is an address posture, “Yes” is determined in Step S93, and the address detecting process ends.

Next, another technique other than the address detection technique will be described.

An address posture, for example, can be detected by being matched with images acquired by photographing an address state. However, for example, since there may be situations in which the address posture of a person taking a swing is very similar to that of an impact, or an address form may be taken a plurality of times until an address posture is formed, there is a high possibility of erroneous detection through simply conducting image matching.

Thus, in this example, an address detection technique with a high detection precision that considers the characteristics of a golf swing and does not use matching performed by simply selecting an image with the highest matching rate or the like will be described.

In the address detection process, an identification unit that is stored in advance in the storage unit 19 or the like is used. In the address detection process, an identification score that is acquired by digitizing the degree of matching with an image of an address posture is calculated by using the identification unit.

In this address detection process, first, a frame of an impact is identified in a moving image by using various techniques. In addition, for the detection of an impact, an existing impact detection technique that uses the detection of a change in the position of a ball or the like is used.

In the address detection process, when a predetermined frame image that includes an impact in the moving image is identified through impact detection, the identification unit is applied to each frame photographed before the predetermined frame that includes the identified impact, and the identification scores are recorded.

In the address detection process, a frame of a corresponding address posture is identified from among the frames prior to the frame in which the impact is detected. The reason for this is that, in a golf swing, there is a sequential characteristic of a swing operation in which a swing comprised of a series of operations started from an address posture, is started, and an impact is attained midway.

First, a frame group of a predetermined period, including a frame of an address posture, is roughly identified, and then, the frame of the address is detected by identifying a corresponding frame from among the frame group of the predetermined period, including the frame of the address posture.

The frame group of the predetermined period, including the frame of the address posture, is identified during a period in which the identification score stably varies to meet a predetermined threshold or exceed it.

In a golf swing, there is a predetermined period, in an operation near the address point, from an operation arriving at the address position to the address operation, and thereafter, to an operation after the address operation, a posture similar to the address posture is formed during this period.

In addition, in a case where there are a plurality of periods during which the identification score stably varies to meet a predetermined threshold or exceed it, a frame belonging to a period that is closest to the frame which includes the impact in time is set as the frame group of the predetermined period which includes the frame of the address posture. The reason that the frame group closest to the frame including the impact is an element for identifying the address posture is that a golf swing is comprised of a series of operations ranging from the address posture to the impact.

In the address detection process, thereafter, a frame in which a change in the identification score is the largest, and a sharp change in the inclination of the identification score from among the identified frame group, as described above, is identified as a frame corresponding to an address posture. In addition, in this embodiment, the change in the identification score is calculated from a second derivative of the identification score in the frame group.

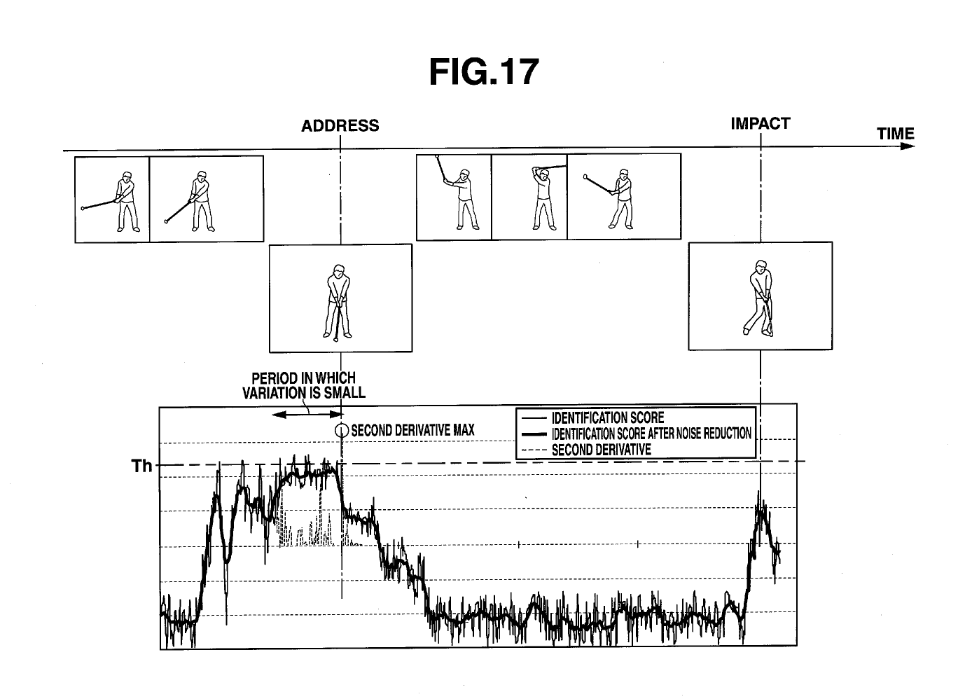

FIG. 17 is a graph that illustrates an example of a transition in the identification score of a frame prior to a frame including an impact.

In the graph, the vertical axis indicates the value of the identification score, and the horizontal axis indicates the time. In addition, a thick line indicates an identification score that is an output value of the identification unit, a thin line indicates an identification score to which a low pass filter process is applied, and a broken line indicates a second derivative in a predetermined section.

As illustrated in the example indicated in FIG. 17, frames disposed on the periphery of an impact and frames near an address posture which include the address posture have high identification scores. Since an impact is detected using another technique, frames near the impact are not detected as frames of address postures.

A frame group of which a period, in which the identification score surpasses a predetermined threshold (Th) that is experimentally derived through an experiment or the like, exceeds a predetermined time (a predetermined frame number) to stably vary, is included in a period having a small variation and consequently, corresponds to a frame group of a predetermined period, including the frame of an address posture.

In addition, among a frame group of a predetermined period, including the frame of the address posture, a frame having a maximum value (second derivative MAX) of the second derivative acquired from frames belonging to a period T is the frame of the address posture.

Thus, according to this address detection technique, the characteristics of a golf swing are considered, and a frame of an address posture can be detected with high precision.

Next, another finish detection technique will be described. Regarding the finish, although a frame after the elapse of a predetermined time from the frame of an impact is set as the frame of a finish, the present invention is not limited thereto, and the detection may be performed using another technique.

In addition, for the detection of a finish, similar to the address detection, the process is performed using an identification unit that is specialized for the detection. Furthermore, also for the detection of an impact, similar to the detection of an address posture, an existing impact detection technology is used.

For the detection of a finish, first, an identification score of each frame is derived by the identification unit for frames after the frame in which the impact has been detected, and an identification score (hereinafter, referred to as an “identification score after noise reduction) which is acquired by processing each derived identification score for noise reduction using a low pass filter, is derived, and the identification scores are respectively recorded.

The reason for setting the frames after the detected impact as detection targets is that the finish operation occurs after the impact.

The detection of a finish is performed by using the derived identification scores and the identification scores after noise reduction. First, the detection of a finish is performed by identifying a frame group having a state in which the identification score that exceeds a predetermined threshold is to continue for a predetermined period, and then belong to a period that has the identification score positioned between another threshold higher than the predetermined threshold and the predetermined threshold which is then continued for a predetermined period. Accordingly, in the detection of a finish, there is the maintenance of period in which a posture is more similar to a finish, and the period until the finish is released can be identified.

The detection of a finish is performed by identifying a frame group that is the closest to the frame in which an impact has been detected from among the identified frame group. The frame group of this period is a frame group that includes the frame of a finish.

In a golf swing, for example, there are cases where the posture of a finish is intentionally taken several times after a finish out of personal habit or the like, and, by setting the frame group that is closest to a frame in which an impact has been detected as a frame group that includes a finish, a corresponding scene is excluded, and the finish, which is an end point of a swing operation, is identified.

Then, a frame of a finish is identified from a frame indicative of a highest identification score after noise reduction from among frames belonging to an identified period. As a result, a frame which is closest to the finish of a swing and has no noise, is identified.

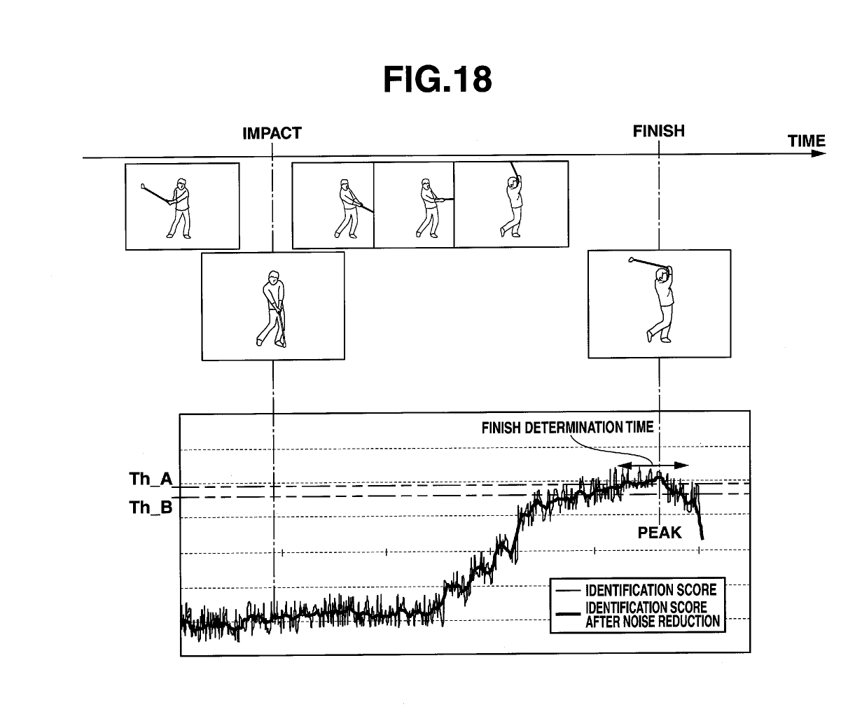

FIG. 18 is a graph that illustrates an example of a transition in the identification score of a frame after the frame that includes the impact.

In the graph, the vertical axis indicates the value of the identification score, and the horizontal axis indicates the time. In addition, a thick line indicates the identification score which represents the output value of the identification unit, and a thin line indicates the identification score after noise reduction.

As illustrated in the example indicated in FIG. 18, the identification score gradually increases as the operation approaches the operation of a finish following the impact. Then, the identification score sharply decreases after indicating a high value for a predetermined period. The reason for the identification score sharply decreasing after indicating the high value for the predetermined period is that the swing operation is stopped after the finish.

A period in which the identification score exceeds a predetermined threshold (Th_A) that is derived experimentally through an experiment or the like exceeds a predetermined time (predetermined frame number), and a predetermined period (finish determination period) in which the identification score is between the threshold (Th_A) and a predetermined threshold (Th_B) that is derived experimentally through an experiment or the like corresponds to a frame group that includes a finish.

Then, a frame in which the identification score after noise reduction indicates the highest value (peak) among a frame group of a predetermined period, including a frame of a finish, is the frame of the finish.

Thus, according to this finish detection technique, the characteristics of a golf swing are considered, and the frame of a finish can be detected with high precision.

In addition, the process relating to the address detection and the finish detection described above may be configured to be performed by the extraction time point identifying unit 55.

The image capture apparatus 1, as described above, is equipped with: the CPU 11; the image capture unit 16; the impact detection processing unit 54; the extraction time point identifying unit 55; and the moving image storage control unit 56.

The CPU 11 acquires a moving image photographed by the image capture unit 16.

The impact detection processing unit 54 identifies a predetermined time point in the moving image that is acquired by the CPU 11.

The extraction time point identifying unit 55 identifies a starting time point of extraction and/or an ending time point of extraction in the moving image based on a time point of extraction that is identified by the impact detection processing unit 54.

The moving image storage control unit 56 extracts a moving image of a predetermined period from the moving image based on the starting time point and/or the ending time point of extraction that is identified by the extraction time point identifying unit 55.

Accordingly, since the image capture apparatus 1 extracts a moving image of a predetermined period from the moving image based on the starting time point or the ending time point identified by the extraction time point identifying unit 55, the moving image of a period that is desired by the user can be extracted.

In addition, the impact detection processing unit 54 identifies a predetermined time point based on a difference value between the frames of the moving image and/or a difference value according to template matching. Thus, according to the image capture apparatus 1, the precision of the identification of the predetermined time can be improved.

In addition, the impact detection processing unit 54 further includes: an impact candidate determining unit 545 that determines whether the difference value of the template matching meets a predetermined threshold or exceeds it; and an impact determining unit 546 that determines the continuation state of a frame corresponding to the threshold, which has been determined to be a predetermined threshold or more by the impact candidate determining unit 545, and identifies a predetermined time point based on a result of the determination made by the impact determining unit 546.

Therefore, according to the image capture apparatus 1, the precision of the identification of a predetermined time point can be improved.

In addition, the extraction time point identifying unit 55 calculates a value according to the template matching each frame of the moving image.

Furthermore, the extraction time point identifying unit 55 identifies a starting time point and/or an ending time point based on the value calculated by the impact evaluation value calculating unit 544.

Therefore, in the image capture apparatus 1, the starting time and ending point that have a value that accords with the template matching for each frame of the moving image that is being used as the reference can be identified, and accordingly, the starting time point and the ending time point can be identified with high precision.

In addition, the extraction time point identifying unit 55 calculates a displacement of the value according to the template matching.

Furthermore, the extraction time point identifying unit 55 identifies a time point at which the displacement calculated by the impact evaluation value calculating unit 544 prior to the predetermined time point is a maximum as the starting time point and/or the ending time point.

Therefore, according to the image capture apparatus 1, the starting time point and the ending time point that have the displacement of the value that accords with the template matching which is used as the reference can be identified, and accordingly, the starting time point and the ending time point can be identified with high precision.

In addition, the extraction time point identifying unit 55 identifies a time point at which the value of the template matching is a maximum from a predetermined period in which the value that accords with the template matching meets a predetermined threshold or exceeding it after the predetermined time point is used as the starting time point and/or the ending time point.

Therefore, according to the image capture apparatus 1, since the starting time point and the ending time point have the time point at which the value of the template matching is the maximum being used, the reference can be identified, and the starting time point and the ending time point can be identified with high precision.

In addition, the image capture apparatus 1 further includes the ring buffer 71 that stores image data used for template matching corresponding to the time point of extraction.

The extraction time point identifying unit 55 identifies the starting time point of the extraction of the moving image and/or the ending time point of the extraction as time points of the extraction for a predetermined period based on the image data that is stored in the ring buffer 71.

Therefore, according to the image capture apparatus 1, the precision of the identifying of predetermined time points can be improved.

In addition, the extraction time point identifying unit 55 identifies the starting time point of the extraction of the moving image based on frames prior to a predetermined time point and identifies the ending time point of the extraction based on frames after a predetermined time point.

Therefore, according to the image capture apparatus 1, since a starting time point and an ending time point with a predetermined time set as the reference can be identified, the starting time point and the ending time point can be identified with high precision.

Here, the moving image is a moving image of the operation of a person taking a golf swing.

The impact detection processing unit 54 identifies a time point of an impact as a predetermined time point.

The extraction time point identifying unit 55 identifies a time point of an address posture as the starting time point and a time point of a finish as the ending time point.

Therefore, according to the image capture apparatus 1, a moving image having the address posture as the starting time point and the finish as the ending time point of a golf swing can be extracted.

The present invention is not limited to the above-described embodiment, but changes, improvements, and the like in the range in which the object of the present invention can be achieved also belong to the present invention.

In the above-described embodiment, in the swing moving image photographing process, frames are configured to be temporarily stored in the ring buffer 71 such that the user taking a swing can take a swing at the timing he desires, regardless of the timing on the image capture apparatus 1 side.

In a swing, since there is the necessary operation of raising the club before an impact, there is a situation in which only a ball is placed within the area frame. Accordingly, it is not necessary to complete the detection of a ball before the start of a swing. In such a case, it is necessary to store frames in the ring buffer 71 after the detection of an entry.

However, the present invention is not limited to the above-described embodiment, and, in order to increase the precision of the detection of a ball and the identification of the position, a ball may be configured to be detected before the start of a swing. However, in such a case, it is necessary to form a state in which only a ball is placed within the area frame, such as a case where the club is operated so it does not enter the inside of the area frame.

When the above-described embodiment and this example are compared with each other, from the viewpoint of certainty (for example, the detection ratio of a ball), it is more effective to employ this example, and, from the viewpoint of usability (for example, the consecutive operability of golf), it is more effective to employ the above-described embodiment.

In addition, in the above-described embodiment, although an impact is detected using a specific technique, and an address posture is detected using a result of the detection of an impact, the present invention is not limited thereto. The detection of an impact and the detection of an address posture may be performed by using various techniques, and only the detection of an address posture may be used by using various techniques.

In addition, in the above-described embodiment, while frames between two time points of the starting time point and the ending time point that respectively correspond to an address posture in the starting time point of a swing as a starting time point of a moving image and a finish in the ending time point of the swing as an ending time point are stored, only the starting time point or only the ending time point may be used. Furthermore, the predetermined time point may be configured to be the center of the moving image on the time axis. In such a case, a time point that is predetermined or a predetermined number of frames before a predetermined time point is set as the starting time point, and a time point that is predetermined or a predetermined number of frames after the predetermined time point is set as the ending time point.

In addition, with respect to the detection of the frame of a finish, a case where a frame after the elapse of a predetermined time from the frame of an impact is detected as the frame of a finish and a case where the frame of a finish is detected using a predetermined threshold have been described; however, the method of determining the frame of a finish is not limited thereto.

For example, similar to the detection of an address posture, the frame of a finish may be detected by using detection information of an identification unit that is used for detecting the frame of a finish.

To the contrary, when an address posture is detected, a frame that is a predetermined time prior to the frame of an impact or a frame meeting a predetermined threshold or exceeding it may be configured to be detected as the frame of an address posture.

In addition, in the above-described embodiment, although the second evaluation value according to the template and the identification score according to the identification unit have been described as mutually-different concepts, the concept of the template and the concept of the identification unit may be configured to be substantially the same, and, as the technique for detecting an impact, a finish, or an address posture, any one of the above-described techniques may be applied.

Furthermore, in the above-described embodiment, in order to reduce the volume of the moving image and improve the searchability, although an address posture in the starting time point of a swing is configured to be detected, the present invention is not limited thereto. It may be configured such that a specific posture of a swing and operations performed thereafter may be stored as a moving image, or, in such a way that one specific posture or state to another specific posture or state is stored as a moving image.

In addition, in the above-described embodiment, although a golf swing has been described as an example, the present invention is not limited thereto. The present invention is not limited to a sport other than golf, it may be configured such that a specific operation or state is detected, and a moving image is stored only during predetermined operations or states.

Furthermore, in the above-described embodiment, while the high-speed camera has been described as an example, the present invention is not limited thereto, an ordinary digital camera capable of photographing a moving image may also be used.

In addition, in the above-described embodiment, while the image capture apparatus 1 to which the present invention is applied has been described as a digital camera, the application of the present invention is not limited thereto.

For example, the present invention may be applied to a general electronic device that has a swing moving image photographing function. More specifically, for example, the present invention may be applied to a notebook-type personal computer, a printer, a television set, a video camera, a portable navigation device, a smartphone, a cellular phone, a portable game device, or the like.

The above-described series of processes may be performed either by hardware or by software.

In other words, the functional configuration in FIG. 3 is merely an example, and the present invention is not particularly limited thereto. In other words, it is sufficient if a function for performing the above-described series of processes as a whole is included in the image capture apparatus 1, and the functional blocks to be used for realizing this function are not particularly limited to the example in FIG. 3.

In addition, one functional block may be configured solely by hardware, may be configured solely by software, or may be configured by a combination of software and hardware.

In a case where the series of processes is performed by software, a program configuring the software is installed to a computer or the like from a network or a recording medium.

The computer may be a computer that is built in dedicated hardware. In addition, the computer may be a computer capable of executing various functions by installing various programs thereto, for example, a general-purpose personal computer.

A recording medium including such a program is, in addition to being configured by the removable medium 31 in FIG. 2 that is distributed separately from the apparatus main body for provision of program to users, is also provided to users through being configured by a recording medium or the like that is incorporated in the apparatus's main body in advance. The removable medium 31, for example, is configured by a magnetic disk (including a floppy disk), an optical disc, a magneto-optical disk, or the like. For example, the optical disc is configured by a compact disk-read only memory (CD-ROM), a digital versatile disk (DVD), a Blu-ray disc (BD), or the like. The magneto-optical disk is configured by a Mini-Disk (MD) or the like. In addition, the recording medium that is provided to users in advance through incorporation in the main body of the apparatus, for example, is configured by the ROM 12 in FIG. 2 in which a program is recorded, a hard disk included in the storage unit 19 in FIG. 2, or the like.

Furthermore, in the description presented here, steps describing a program recorded on a recording medium not only include processes performed in a time series in accordance with the sequence thereof, but also include processes that are not necessarily performed in a time series, but are performed in a parallel manner or individually.

As above, several embodiments of the present invention have been described. However, such embodiments are merely examples and are not for purposes of limiting the technical scope of the present invention. The present invention may take other various embodiments, and various changes, such as an omission or substitution and the like may be made in a scope that does not depart from the concept of the present invention. These embodiments and modifications thereof are included in the scope or the concept of the invention described here and are included in the invention described in the claims and the scope equivalent thereto.

1. A moving image extracting apparatus comprising:
an acquisition unit that acquires a first moving image;
an identification unit that identifies a predetermined time point in the first moving image acquired by the acquisition unit;
a calculation unit that calculates reliability of a period in the first moving image; and
an extraction unit that extracts, from the first moving image, a second moving image of a predetermined period according to the predetermined time point and the reliability.

2. The moving image extracting apparatus according to claim 1,
wherein the identification unit identifies the predetermined time point in accordance with a difference value between adjacent frames in the first moving image and/or an evaluation value for a frame of the first moving image according to template matching.

3. The moving image extracting apparatus according to claim 2,
wherein the identification unit further comprises:
a threshold determining unit that determines whether the evaluation value according to the template matching is a predetermined threshold or more; and
a state determining unit that determines a continuation state of frames, each of the frames having evaluation values determined to be the predetermined threshold or more by the threshold determining unit,
wherein the predetermined time point is identified based on a determination result according to the state determining unit.

4. The moving image extracting apparatus according to claim 2,
wherein the calculation unit calculates the evaluation value according to the template matching for each frame of the first moving image.

5. The moving image extracting apparatus according to claim 4,
wherein the calculation unit further calculates a displacement of evaluation values according to the template matching, and
wherein the extraction unit extracts, as a starting time point of extraction, the predetermined period with a time point which is before the predetermined time point.

6. The moving image extracting apparatus according to claim 4,
wherein the extraction unit extracts the predetermined period from a period in which an evaluation value according to the template matching is a predetermined threshold or more after the predetermined time point, to a time point at which an evaluation value according to the template matching is maximal as an ending time point of the extraction.

7. The moving image extracting apparatus according to claim 1,
further comprising:
a storage unit that stores image data used for the template matching corresponding to a starting time point of the predetermined period and/or an ending time point in the moving image,
wherein the calculation unit calculates, based on the image data stored in the storage unit, the reliability of a starting time point of extraction of the moving image and/or an ending of the extraction in the predetermined period.

8. The moving image extracting apparatus according to claim 1,
wherein the calculation unit calculates the reliability of a starting time point from frames prior to the predetermined time point and calculates reliability of an ending time point from frames after the predetermined time point.

9. The moving image extracting apparatus according to claim 1,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

10. A method of extracting a moving image using a moving image extracting apparatus, the method comprising:
acquiring a first moving image;
identifying a predetermined time point in the first moving image acquired in the acquisition of the first moving image;
calculating the reliability of a period in the first moving image; and
extracting, from the first moving image, a second moving image of a predetermined period according to the predetermined time point and the reliability.

11. A non-transitory recording medium on which a computer-readable program is recorded, the computer-readable program causing a computer to perform functions as:
an acquisition unit that acquires a first moving image;
an identification unit that identifies a predetermined time point in the first moving image acquired by the acquisition unit;
a calculation unit that calculates the reliability of a period in the first moving image; and
an extraction unit that extracts, from the first moving image, a second moving image of a predetermined period according to the predetermined time point and the reliability.

12. The moving image extracting apparatus according to claim 2,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

13. The moving image extracting apparatus according to claim 3,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

14. The moving image extracting apparatus according to claim 4,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

15. The moving image extracting apparatus according to claim 5,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

16. The moving image extracting apparatus according to claim 6,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

17. The moving image extracting apparatus according to claim 7,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.

18. The moving image extracting apparatus according to claim 8,
wherein the moving image is a moving image of an operation of a person who takes a swing,
wherein the identification unit identifies the time point of an impact as the predetermined time point, and
wherein the calculation unit calculates the reliability of a time point of a ready posture of the swing as the starting time point and calculates reliability of a time point of a finish posture of the swing as the ending time point, with the predetermined time point being set as the starting point for time point calculation.
